(19) United States
(12) Patent Application Publication
(10) Pub. No.: US 2023/0109442 A1
(43) Pub. Date: Apr. 6, 2023

(54) Readout circuit and output circuit for reducing resistance

(71) Applicant: NOVATEK Microelectronics Corp., Hsin-Chu (TW)

(72) Inventor: Yen-Cheng Cheng, Hsinchu City (TW)

(73) Assignee: NOVATEK Microelectronics Corp., Hsin-Chu (TW)

(21) Appl. No.: 17/491,541

(22) Filed: Oct. 1, 2021

(51) Int. Cl. G09G 3/36; H03F 3/45; G06F 3/0354; G06F 3/041

(52) U.S. Cl. CPC G09G 3/3614; H03F 3/45; G06F 3/03545; G06F 3/04164; H03F 2203/45151; G09G 2300/0828; G09G 2310/0291

(57) ABSTRACT

A readout circuit includes a plurality of input terminals and an amplifier. The amplifier is coupled to at least one of the plurality of input terminals through a readout channel and a replica channel. The amplifier includes a positive input terminal, a negative input terminal and an output terminal. The negative input terminal of the amplifier is coupled to each of the at least one input terminal of the readout circuit through the replica channel. The output terminal of the amplifier is coupled to each of the at least one input terminal of the readout circuit through the readout channel.

### BACKGROUND OF THE INVENTION

### 1. Field of the Invention

The present invention relates to a readout circuit and an output circuit, and more particularly, to a readout circuit for a sensor and an output circuit for a display panel.

### 2. Description of the Prior Art

In various electronic products such as mobile phones, GPS navigator systems, monitors, laptops and computers, a touch panel is widely utilized as the interface for data communication. The touch panel is a human-based input device, which complies with requirements for hierarchy menu, and possesses keyboard and mouse functions and human-based operations such as handwriting input as well. Particularly, the touch panel is capable of integrating input and output functions in the same interface, e.g. the screen. This feature is far superior to the conventional input devices.

A readout circuit is usually used to receive touch sensing signals from the touch panel. In general, the readout circuit may receive the touch sensing signals from the touch panel. An analog front-end (AFE) circuit may be implemented in the readout circuit or coupled to the readout circuit, for amplifying the touch sensing signals and then forward the touch sensing signals to back-end circuits for necessary signal processing. In order to reduce the number of AFE circuits and the detection time, multiple sensor pads may be coupled to one AFE circuit through control of the switches. However, the on-resistance of the switches and the parasitic resistance of the routing wires may decrease the sensing currents received by the AFE circuit. Further, when the touch panel performs stylus detection, the switches coupled between multiple sensor pads and the same AFE circuit may be turned on simultaneously, resulting in tremendous current loss.

On the other hand, the display function of the touch panel is driven by a source driving circuit, which usually includes an operational amplifier (op-amp) implemented in the output stage. The op-amp is used to output currents to drive the loading on the panel. However, the output switches of the op-amp also have on-resistance. The on-resistance and other parasitic resistance of the routing wires may decrease the output capability of the op-amp, thereby reducing the charging speed for the panel loading.

Thus, there is a need for providing a novel readout circuit and output circuit, for reducing the influences of parasitic resistance in the signal path.

### SUMMARY OF THE INVENTION

It is therefore an objective of the present invention to provide a readout circuit and an output circuit in which the feedback path of the operational amplifier is connected to the input/output pad, in order to solve the abovementioned problems.

An embodiment of the present invention discloses a readout circuit, which comprises a plurality of input terminals and an amplifier. The amplifier is coupled to at least one of the plurality of input terminals through a readout channel and a replica channel. The amplifier comprises a positive input terminal, a negative input terminal and an output terminal. The negative input terminal of the amplifier is coupled to each of the at least one input terminal of the readout circuit through the replica channel. The output terminal of the amplifier is coupled to each of the at least one input terminal of the readout circuit through the readout channel.

Another embodiment of the present invention discloses an output circuit, which comprises a plurality of output terminals and an amplifier. The amplifier is coupled to at least one of the plurality of output terminals through an output channel and a replica channel. The amplifier comprises a positive input terminal, a negative input terminal and an output terminal. The negative input terminal of the amplifier is coupled to each of the at least one output terminal of the output circuit through the replica channel. The output terminal of the amplifier is coupled to each of the at least one output terminal of the output circuit through the output channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a general sensing system.

FIG. 2 illustrates the equivalent circuit model of the sensing system shown in FIG. 1.

FIG. 3 is a schematic diagram of a sensing system according to an embodiment of the present invention.

FIG. 4 illustrates the equivalent circuit model of the sensing system shown in FIG. 3.

FIGS. 5A and 5B are schematic diagrams of a general output circuit.

FIGS. 6A, 6B, 7A and 7B are schematic diagrams of an output circuit according to an embodiment of the present invention.

### DETAILED DESCRIPTION

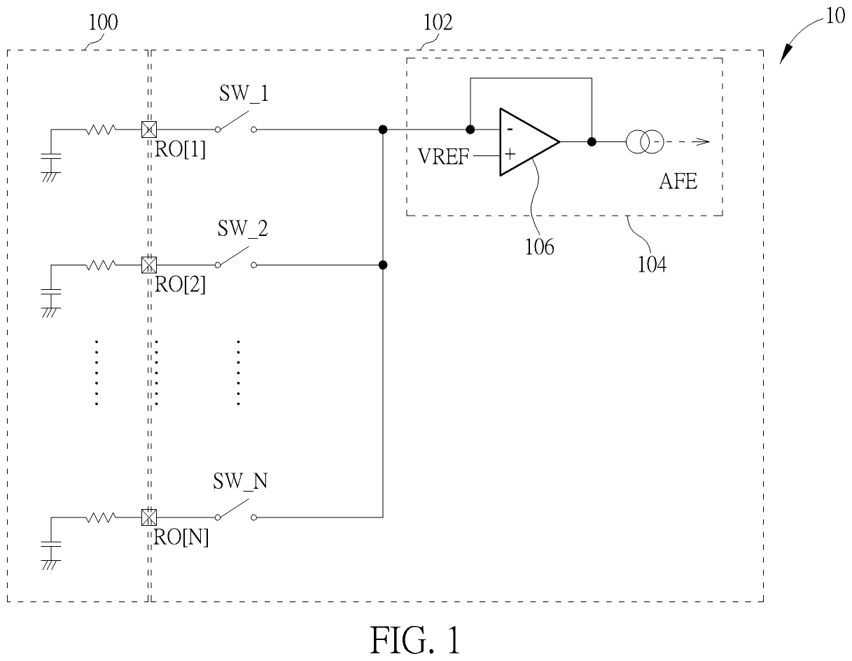

Please refer to FIG. 1, which is a schematic diagram of a general sensing system 10. As shown in FIG. 1, the sensing system 10 includes a sensor 100 and a readout circuit 102. The sensor 100 may be a touch sensor having multiple sensor pads implemented as an array. The sensor 100 may be a stand-alone sensor or may be a touch sensor implemented on or integrated with a display panel to realize a touch panel. The readout circuit 102 includes a plurality of input terminals RO[1]-RO[N], a plurality of switches SW_1-SW_N, and an analog front-end (AFE) circuit 104. The readout circuit 102 is coupled to the sensor 100 through the input terminals RO[1]-RO[N]. The resistors and capacitors in the sensor 100 coupled to the input terminals RO[1]-RO[N] are used to represent the resistive and capacitive loading of the sensor 100 confronted by the readout circuit 102 on each input terminal RO[1]-RO[N]. The AFE circuit 104 is coupled to the input terminals RO[1]-RO[N] through the switches SW_1-SW_N, respectively. The AFE circuit 104 may include an operational amplifier (op-amp) 106, which is configured to receive a sensing signal from the sensor 100 through any of the switches SW_1-SW_N. For example, the op-amp 106 may receive the sensing signal from one or more input terminals RO[1]-RO[N], and detect the voltage of the sensing signal based on a reference voltage VREF, to output a current signal based on the detection result. In this example, the op-amp 106 is connected as a unity gain buffer, where the output terminal is connected to the negative input terminal.

In general, each of the input terminals RO[1]-RO[N] may be coupled to one or more sensor pads on the sensor 100, and the readout circuit 102 may include hundreds of input terminals for the sensor 100. In order to reduce the number of AFE circuits used in the readout circuit 102 and the time for performing sensing, one AFE circuit may be coupled to multiple input terminals, as the structure shown in FIG. 1. However, this implementation may result in a tremendous current loss.

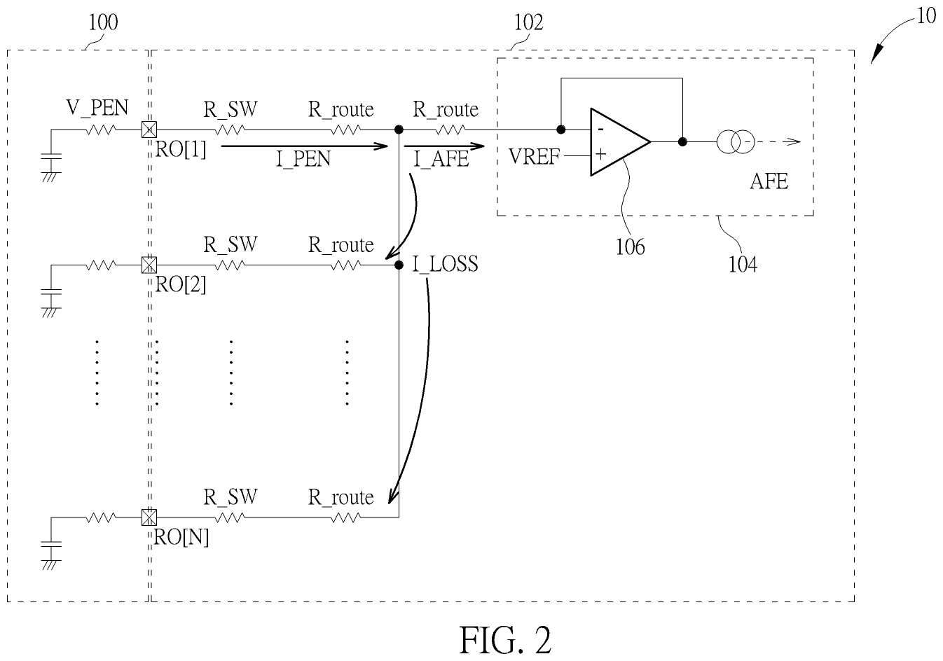

FIG. 2 illustrates the equivalent circuit model of the sensing system 10 shown in FIG. 1. When the sensing system 10 performs stylus detection, several or all of the switches SW_1-SW_N are turned on simultaneously. For example, in a stylus detection mode, the readout circuit 102 may detect a stylus signal along the x-direction and the y-direction, respectively; hence, the input terminals RO[1]-RO[N] with the turned-on switches SW_1-SW_N may be connected to a row of sensor pads or a column of sensor pads. The readout circuit 102 thereby scans the sensor pads in the x-direction and the y-direction to obtain the x-coordinate and y-coordinate of the stylus signal, so as to determine the position of the stylus.

Supposing that each turned-on switch SW_1-SW_N has an on-resistance R_SW, the signal path between the AFE circuit 104 and each input terminal RO[1]-RO[N] includes the on-resistance R_SW of the switches SW_1-SW_N and parasitic resistance R route of the routing wires. If a stylus contacts the sensor 100, the sensor pad contacted by the stylus may generate a voltage variation as a voltage signal V_PEN. This voltage variation may be detected on the input terminal connected to the sensor pad (e.g., the input terminal RO[1] as shown in FIG. 2). A corresponding current signal I_PEN may be generated and received by the readout circuit 102 from the input terminal RO[1]. However, the voltage signal V_PEN may be attenuated as the corresponding current signal I_PEN passes through the resistance R_SW and R route. A current loss I_LOSS may also flow to other input terminals RO[2]-RO[N]. In such a situation, the current signal I_AFE actually received by the AFE circuit 104 may be quite low, especially when the AFE circuit 104 is connected to a great number of input terminals. The op-amp 106 then forwards the current signal I_AFE to back-end circuits for subsequent processing. The decreased current signal I_AFE will reduce the performance of stylus detection.

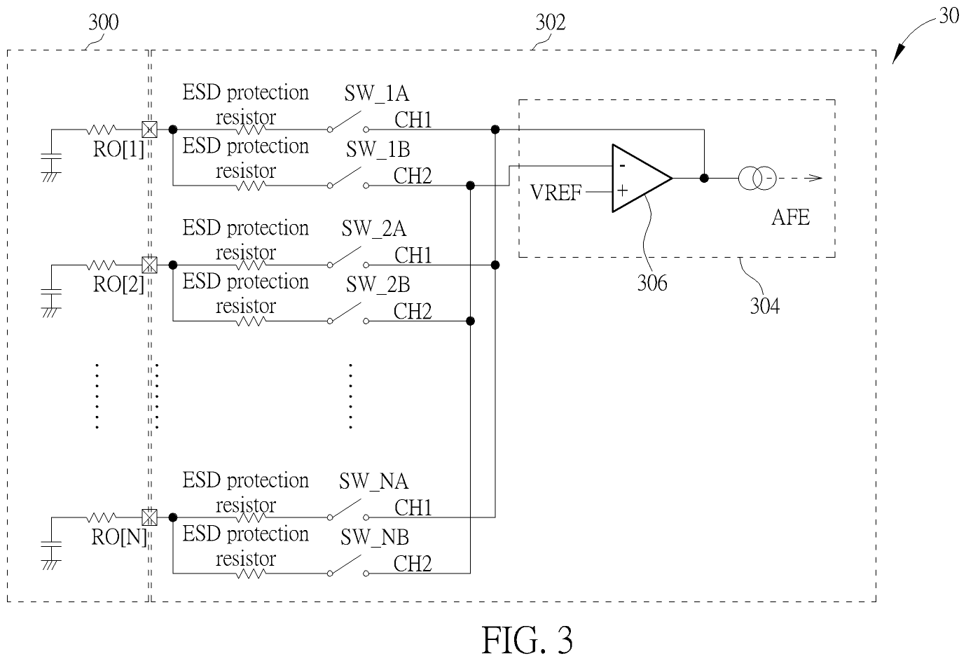

In order to reduce the influences of channel attenuation and current loss, the present invention provides a novel structure of the readout circuit. Please refer to FIG. 3, which is a schematic diagram of a sensing system 30 according to an embodiment of the present invention. As shown in FIG. 3, the sensing system 30 includes a sensor 300 and a readout circuit 302. The structure of the sensor 300 is identical to the structure of the sensor 100, and thus will not be detailed herein. The readout circuit 302, which may be included in a sensing circuit for receiving and processing sensing signals from the sensor 300, includes a plurality of input terminals RO[1]-RO[N], a plurality of switches SW_1A-SW_NA and SW_1B-SW_NB, and an AFE circuit 304. More specifically, the readout circuit 302 is coupled to the sensor 300 through the input terminals RO[1]-RO[N]. The AFE circuit 304 includes an op-amp 306, and may further include other circuit elements such as an integrator and/or a gain amplifier, which are omitted herein without affecting the illustration of the present embodiment. In an embodiment, the AFE circuit 304 may further include a current mirror and a current integrator. The current signal received by the op-amp 306 may be forwarded to the current mirror, which may duplicate the current signal to be accumulated in the current integrator.

In the readout circuit 302, the op-amp 306 is coupled to each of the input terminals RO[1]-RO[N] through a readout channel CH1 and also through a replica channel CH2. More specifically, the output terminal of the op-amp 306 is coupled to the input terminals RO[1]-RO[N] of the readout circuit 302 through the readout channel CH1. The switches SW_1A-SW_NA are implemented in the readout channel CH1, to be coupled between the output terminal of the op-amp 306 and the input terminals RO[1]-RO[N] of the readout circuit 302, respectively. The negative input terminal of the op-amp 306 is coupled to the input terminals RO[1]-RO[N] of the readout circuit 302 through the replica channel CH2. The switches SW_1B-SW_NB are implemented in the replica channel CH2, to be coupled between the negative input terminal of the op-amp 306 and the input terminals RO[1]-RO[N] of the readout circuit 302, respectively. The switches SW_1A-SW_NA and SW_1B-SW_NB may be served as select switches for controlling the op-amp 306 and the AFE circuit 304 to be selectively coupled to one or more of the input terminals RO[1]-RO[N]. For example, in a stylus detection mode, the switches SW_1A-SW_NA and SW_1B-SW_NB may be turned on simultaneously, to perform stylus detection on a row or a column of sensor pads. In a finger touch detection mode, the switches SW_1A-SW_NA and SW_1B-SW_NB may be turned on time-divisionally, to perform finger touch detection on each sensor pad. Note that a switch in the replica channel CH2 should be turned on when the corresponding switch in the readout channel CH1 coupled to the same input terminal is turned on, so as to construct the feedback path of the op-amp 306.

In an embodiment where the stylus detection is performed and the switches SW_1A-SW_NA and SW_1B-SW_NB are turned on simultaneously, the feedback structure of the op-amp 306 where the feedback path is connected to the input terminal through the replica channel CH2 may achieve the benefits of preventing the current signal from being attenuated with the resistance in the signal path and also reducing the current losses to other input terminals. In an embodiment where the finger touch detection is performed and the switches SW_1A-SW_NA and SW_1B-SW_NB are turned on time-divisionally, no current losses to other input terminals may occur since the corresponding switches are off, and the feedback structure of the op-amp 306 may still achieve the benefits of preventing the current signal from being attenuated with the resistance in the signal path.

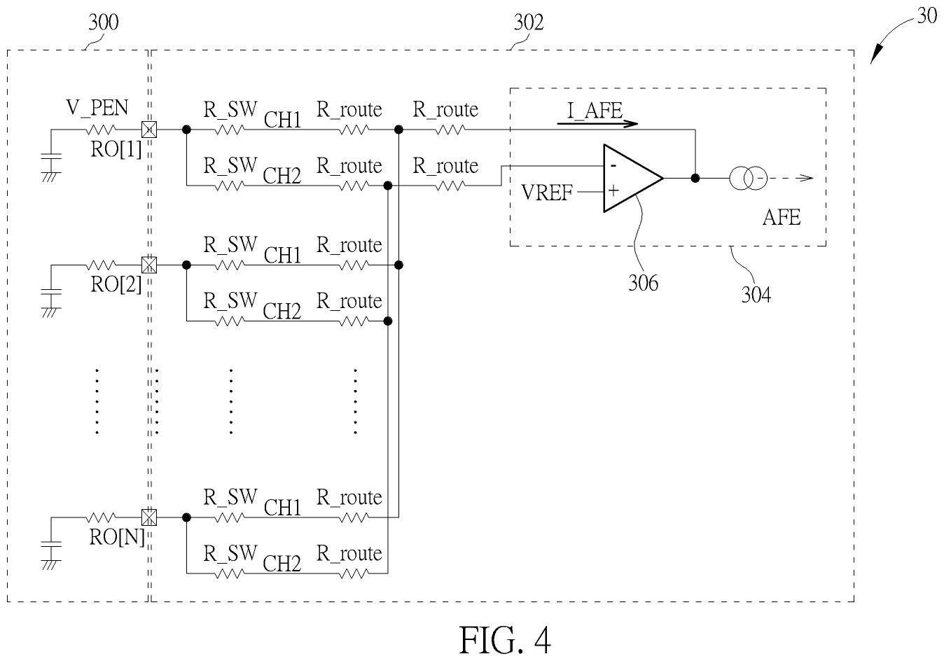

FIG. 4 illustrates the equivalent circuit model of the sensing system 30 shown in FIG. 3. Similarly, each turned-on switch SW_1A-SW_NA and SW_1B-SW_NB may have a non-resistance R_SW. Therefore, the signal path, including the readout channel CH1 and the replica channel CH2, between the AFE circuit 304 and each input terminal RO[1]-RO[N] includes the on-resistance R_SW of the switches SW_1A-SW_NA and SW_1B-SW_NB and parasitic resistance R route of the routing wires.

As shown in FIG. 4, the output terminal of the op-amp 306 is coupled to each input terminal RO[1]-RO[N] through the readout channel CH1, and the negative input terminal of the op-amp 306 is coupled to each input terminal RO[1]-RO[N] through the replica channel CH2. Therefore, the feedback path of the op-amp 306 will pass through the input terminals RO[1]-RO[N]. In such a situation, the feedback mechanism allows the op-amp 306 to detect the voltage variation on each of the input terminals RO[1]-RO[N], to determine the sensing current based on the voltage variation detected on the input terminals RO[1]-RO[N]. In other words, the feedback node of the op-amp 306 is on the input terminals RO[1]-RO[N] of the readout circuit 302 rather than the input terminal of the op-amp 306.

For example, if a stylus contact appears on the sensor pad coupled to the input terminal RO[1], a voltage signal V_PEN may be generated on the input terminal RO[1]. The op-amp 306 may detect the voltage signal V_PEN and generate the current signal I_AFE based on the voltage signal V_PEN, where the interferences of current losses and resistance may be omitted. More specifically, based on the operation principle of an op-amp, the output current may be generated based on the differential input signals, which equal the voltage difference of the positive input terminal and the negative input terminal of the op-amp. In this embodiment, the positive input terminal of the op-amp 306 may be coupled to a reference node, for receiving a reference voltage VREF. If there is no stylus detected on the sensor 300, the op-amp 306 may be in a balance where the voltages of the input terminals RO[1]-RO[N] and the voltages in the signal path are identical to the reference voltage VREF due to the virtual short-circuit of the input terminals of the op-amp 306. If a stylus contacts a sensor pad connected to the input terminal RO[1], the voltage signal V_PEN will be generated on the input terminal RO[1], and the value of the voltage signal V_PEN may be different from the value of the reference voltage VREF, thereby generating the current signal I_AFE on the output terminal of the op-amp 306. Since the feedback control of the op-amp 306 is based on the variation of the voltage signal V_PEN on the input terminal RO[1], the current losses and signal attenuations between the op-amp 306 and the input terminal RO[1] will be minimized; that is, most currents corresponding to the voltage signal V_PEN may be forwarded to the output terminal of the op-amp 306 as the current signal I_AFE.

In an embodiment, the readout circuit 302 may be included in an integrated circuit (IC). Therefore, the input terminals RO[1]-RO[N] may be input pads of the IC. In such a situation, the feedback node of the op-amp 306 is on the input pads; hence, the attenuations resulting from the resistance in the signal path between the input pads and the op-amp 306 may be eliminated. Such resistance may be generated from the turned-on switches and the parasitic resistance of the routing wires as described above, and/or may also be generated from an electrostatic discharge (ESD) protection resistor. For example, in order to reduce the ESD currents, an ESD protection resistor may be disposed in the readout channel CH1 coupled to each input terminal RO[1]-RO[N], and also disposed in the replica channel CH2 coupled to each input terminal RO[1]-RO[N]. The feedback connections of the op-amp 306 as shown in FIG. 3 may also reduce the signal attenuations caused by the ESD protection resistor in a similar manner.

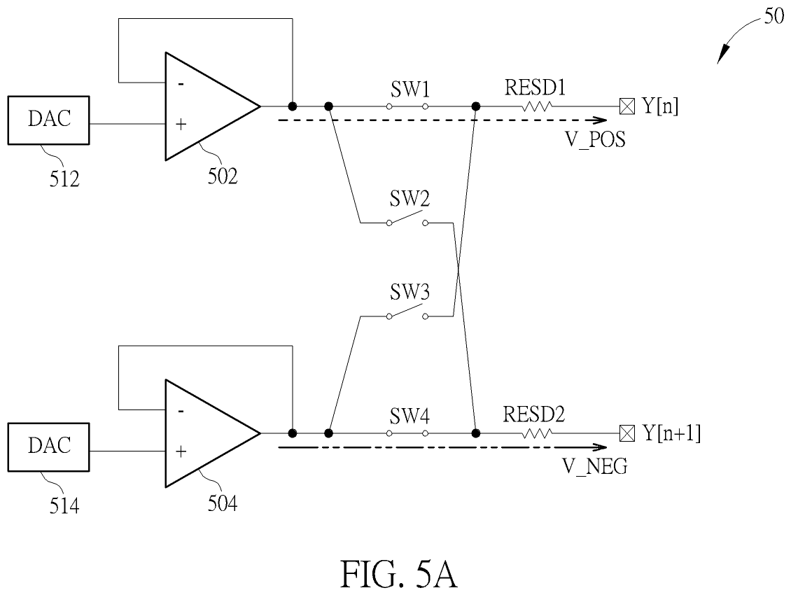

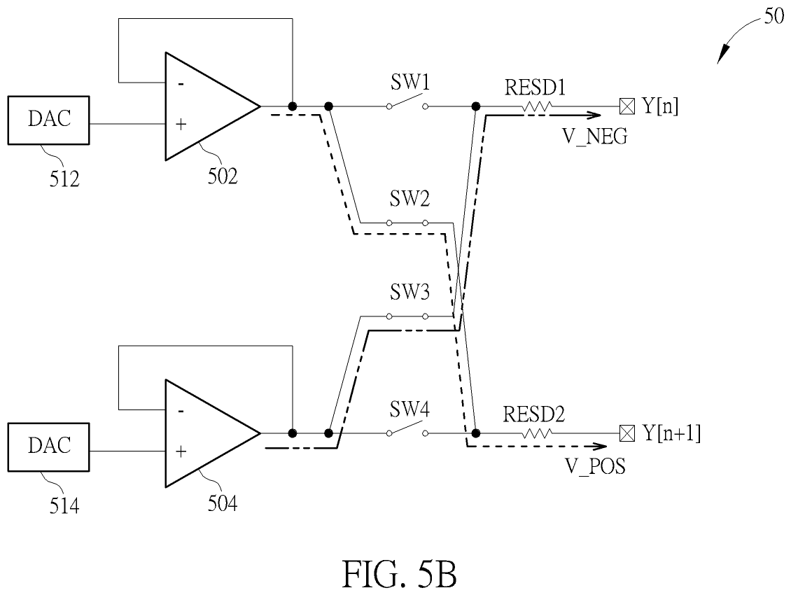

Please refer to FIGS. 5A and 5B, which are schematic diagrams of a general output circuit 50. As shown in FIGS. 5A and 5B, the output circuit 50 includes op-amps 502 and 504, digital-to-analog converters (DACs) 512 and 514, select switches SW1-SW4, ESD protection resistors RESD1 and RESD2, and output terminals Y[n] and Y[n+1]. The output circuit 50 is configured to output image data voltages to a display panel. For example, the output circuit 50 may be used for a liquid crystal display (LCD) panel, where the output terminals Y[n] and Y[n+1] are configured to output a positive data voltage V_POS and a negative data voltage V_NEG alternately, to realize the polarity inversion of the LCD panel. In this example, the op-amp 502 is configured to output the positive data voltage V_POS, and the op-amp 504 is configured to output the negative data voltage V_NEG. The DACs 512 and 514 are coupled to the positive input terminal of the op-amps 502 and 504, respectively, for providing the image data voltages based on the grayscale data. The ESD protection resistors RESD1 and RESD2 are disposed in the output paths of the output terminals Y[n] and Y[n+1], respectively, for limiting the ESD currents.

In detail, FIG. 5A illustrates a polarity configuration where the output terminal Y[n] is used to output the positive data voltage V_POS and the output terminal Y[n+1] is used to output the negative data voltage V_NEG. In this implementation, the select switches SW1 and SW4 are turned on and the select switches SW2 and SW3 are turned off. FIG. 5B illustrates another polarity configuration where the output terminal Y[n] is used to output the negative data voltage V_NEG and the output terminal Y[n+1] is used to output the positive data voltage V_POS. In this implementation, the select switches SW2 and SW3 are turned on and the select switches SW1 and SW4 are turned off.

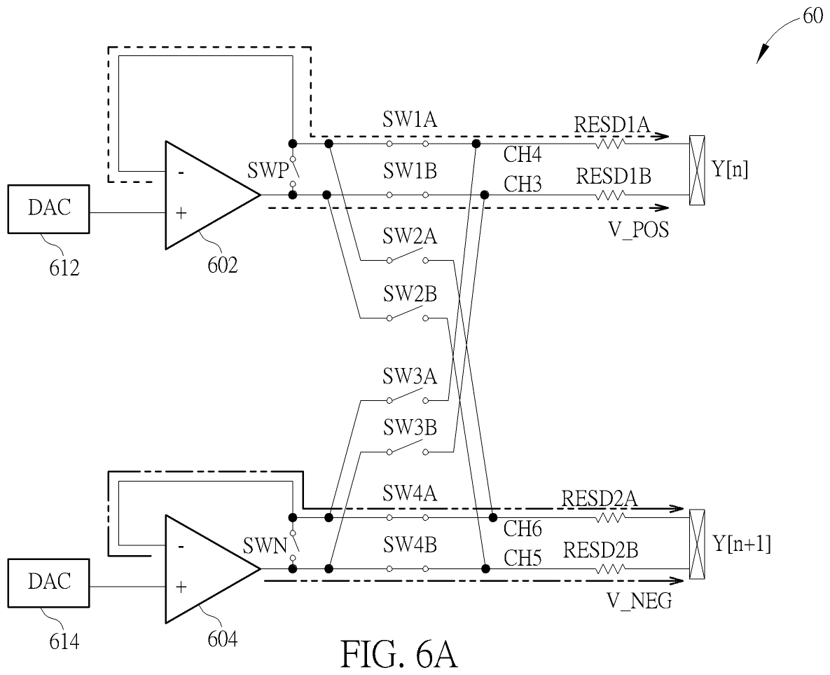

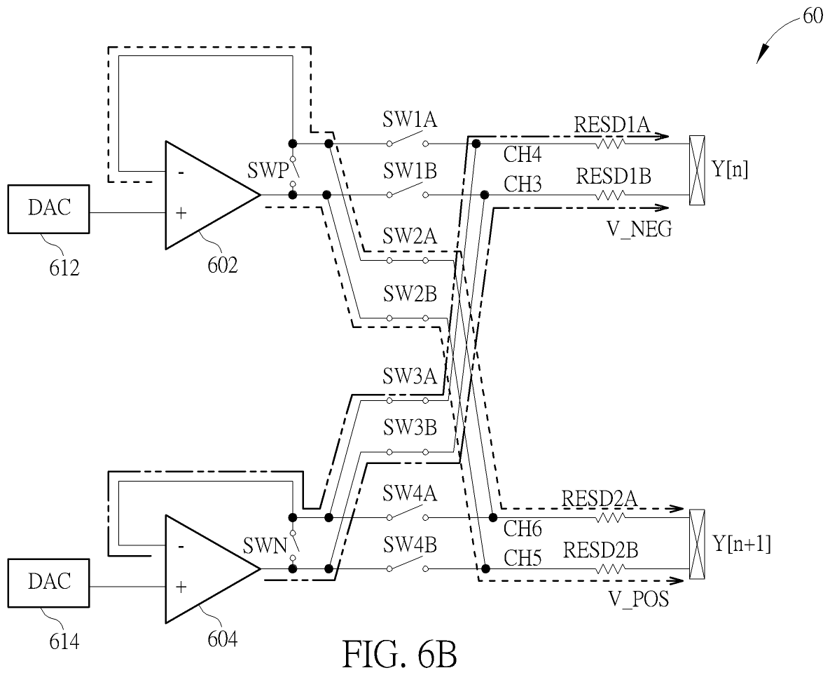

Please refer to FIGS. 6A and 6B, which are schematic diagrams of an output circuit 60 according to an embodiment of the present invention. As shown in FIGS. 6A and 6B, the output circuit 60 includes op-amps 602 and 604, DACs 612 and 614, select switches SW1A-SW4A and SW1B-SW4B, control switches SWP and SWN, ESD protection resistors RESD1A, RESD1B, RESD2A and RESD2B, and output terminals Y[n] and Y[n+1]. The output circuit 60 may be included in a source driving circuit for driving a display panel. Similar to the output circuit 50 shown in FIGS. 5A and 5B, the output circuit 60 is configured to output image data voltages to an LCD panel, where the output terminals Y[n] and Y[n+1] are coupled to the LCD panel and configured to output a positive data voltage V_POS and a negative data voltage V_NEG alternately, to realize the polarity inversion of the LCD panel. The op-amp 602 is configured to output the positive data voltage V_POS, and the op-amp 604 is configured to output the negative data voltage V_NEG, where the data voltages are received from the DACs 612 and 614. The DACs 612 and 614 are coupled to the positive input terminal of the op-amps 602 and 604, respectively, for providing the image data voltages for the op-amps 602 and 604 based on the grayscale data.

The circuit structure of the output circuit 60 is different from the circuit structure of the output circuit 50 in that, each op-amp 602 and 604 is coupled to each of the output terminals Y[n] and Y[n+1] through an output channel and a replica channel, where the output channel and the replica channel both include a select switch and an ESD protection resistor.

In detail, the op-amp 602 is coupled to the output terminal Y[n] through the output channel CH3 and the replica channel CH4, and also coupled to the output terminal Y[n+1] through the output channel CH5 and the replica channel CH6. More specifically, the output terminal of the op-amp 602 is coupled to the output terminal Y[n] through the output channel CH3, where the select switch SW1B and the ESD protection resistor RESD1B are implemented in the output channel CH3, to be coupled between the output terminal of the op-amp 602 and the output terminal Y[n] of the output circuit 60. The negative input terminal of the op-amp 602 is coupled to the output terminal Y[n] through the replica channel CH4, where the select switch SW1A and the ESD protection resistor RESD1A are implemented in the replica channel CH4, to be coupled between the negative input terminal of the op-amp 602 and the output terminal Y[n] of the output circuit 60. The output terminal of the op-amp 602 is further coupled to the output terminal Y[n+1] through the output channel CH5, where the select switch SW2B and the ESD protection resistor RESD2B are implemented in the output channel CH5, to be coupled between the output terminal of the op-amp 602 and the output terminal Y[n+1] of the output circuit 60. The negative terminal of the op-amp 602 is further coupled to the output terminal Y[n+1] through the replica channel CH6, where the select switch SW2A and the ESD protection resistor RESD2A are implemented in the replica channel CH6, to be coupled between the negative input terminal of the op-amp 602 and the output terminal Y[n+1] of the output circuit 60.

In a similar manner, the op-amp 604 is coupled to the output terminal Y[n] through the output channel CH3 including the select switch SW3B and the ESD protection resistor RESD1B, and also through the replica channel CH4 including the select switch SW3A and the ESD protection resistor RESD1A. The op-amp 604 is further coupled to the output terminal Y[n+1] through the output channel CH5 including the select switch SW4B and the ESD protection resistor RESD2B, and also through the replica channel CH6 including the select switch SW4A and the ESD protection resistor RESD2A.

FIG. 6A illustrates a polarity configuration where the output terminal Y[n] is used to output the positive data voltage V_POS and the output terminal Y[n+1] is used to output the negative data voltage V_NEG. In this implementation, the select switches SW1A, SW1B, SW4A and SW4B are turned on and the select switches SW2A, SW2B, SW3A and SW3B are turned off. The control switches SWP and SWN respectively coupled between the negative input terminal and the output terminal of the op-amps 602 and 604 are also turned off. FIG. 6B illustrates another polarity configuration where the output terminal Y[n] is used to output the negative data voltage V_NEG and the output terminal Y[n+1] is used to output the positive data voltage V_POS. In this implementation, the select switches SW2A, SW2B, SW3A and SW3B are turned on and the select switches SW1A, SW1B, SW4A and SW4B are turned off. The control switches SWP and SWN respectively coupled between the negative input terminal and the output terminal of the op-amps 602 and 604 are also turned off.

When the output circuit 60 starts to output new data voltages to charge the display panel and/or when the data voltages change, the control switches SWP and SWN may be turned off. Therefore, the feedback path of the op-amps 602 and 604 will pass through the output terminals Y[n] and Y[n+1]. In such a situation, the feedback mechanism allows the op-amps 602 and 604 to drive the display panel without being influenced by the on-resistance of the select switches SW1A-SW4A and SW1B-SW4B and the ESD protection resistors RESD1A, RESD1B, RESD2A and RESD2B. In other words, with this feedback structure, the select switches SW1A-SW4A and SW1B-SW4B and the ESD protection resistors RESD1A, RESD1B, RESD2A and RESD2B may not limit the output driving capability of the op-amps 602 and 604.

In an embodiment, the output circuit 60 and the corresponding source driving circuit may be included in an IC. Therefore, the output terminals Y[n] and Y[n+1] may be output pads of the IC. In such a situation, the feedback node of the op-amps 602 and 604 is on the output pads; hence, the attenuations resulting from the resistance in the signal path between the op-amps 602 and 604 and the output pads may be eliminated. Such resistance may be generated from the turned-on switches and the ESD protection resistors as described above, and/or may also be generated from the parasitic resistance of the routing wires and other circuit elements having resistive loads.

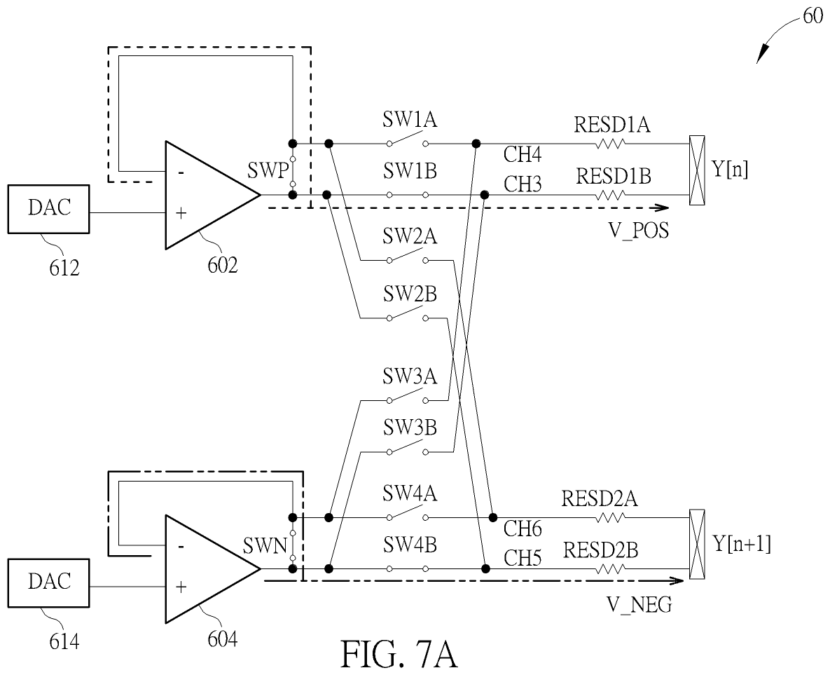

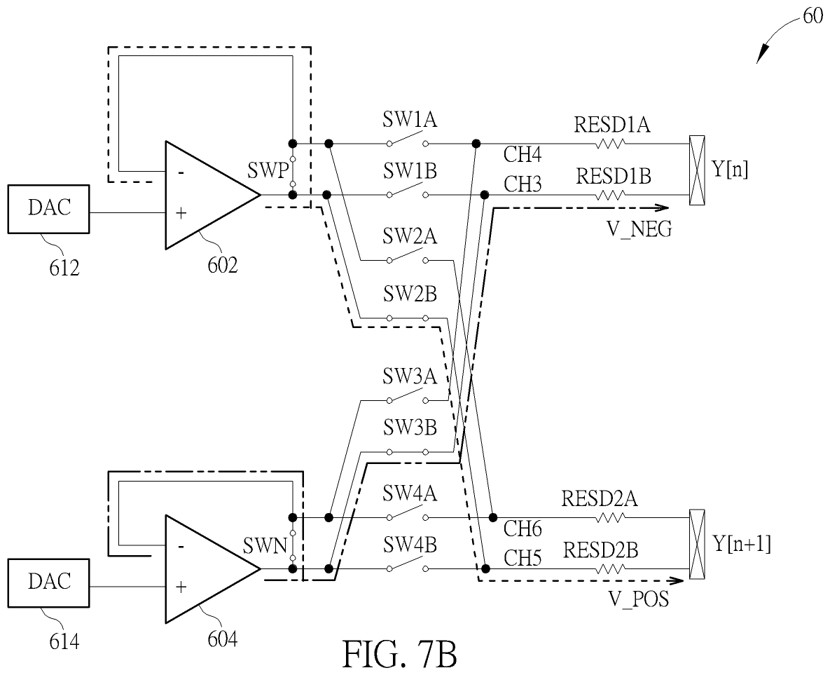

FIGS. 7A and 7B illustrate the output circuit 60 in which the op-amps 602 and 604 are connected as unity gain buffers, where the output terminal of the op-amps 602 and 604 is directly connected to its negative input terminal. As shown in FIGS. 7A and 7B, the control switches SWP and SWN are turned on, allowing the output terminal of each op-amp 602 and 604 to be connected to its negative input terminal. In detail, FIG. 7A illustrates a polarity configuration where the output terminal Y[n] is used to output the positive data voltage V_POS and the output terminal Y[n+1] is used to output the negative data voltage V_NEG, where the select switches SW1B and SW4B are turned on and other select switches are turned off to realize this polarity configuration. FIG. 7B illustrates another polarity configuration where the output terminal Y[n] is used to output the negative data voltage V_NEG and the output terminal Y[n+1] is used to output the positive data voltage V_POS, where the select switches SW2B and SW3B are turned on and other select switches are turned off to realize this polarity configuration.

As mentioned above, when the output circuit 60 starts to output new data voltages to charge the display panel and/or when the data voltages change, the control switches SWP and SWN are turned off and the select switches are conducted appropriately to allow the feedback node of the op-amps 602 and 604 to be on the output terminals Y[n] and Y[n+1]. This implementation increases the transient driving currents of the op-amps 602 and 604 by reducing the influences of the resistance in the signal path, thereby enhancing the driving capability of the output circuit 60. After the display panel is nearly fully charged, the switch connections may change to the configurations as shown in FIGS. 7A and 7B where the control switches SWP and SWN are turned on and the op-amps 602 and 604 are connected as unity gain buffers. In such a situation, the stability of the op-amps 602 and 604 may be improved.

Please note that the present invention aims at providing a readout circuit and an output circuit in which the feedback path of the op-amp is directly connected to the input/output terminal of the readout circuit and the output circuit. Those skilled in the art may make modifications and alterations accordingly. For example, the circuit structure shown in FIG. 3 is merely an example for illustrating the possible structure of the readout circuit of the present invention. According to the present invention, a readout circuit may include multiple AFE circuits, each of which includes an op-amp coupled to one or multiple input terminals with the feedback structure as shown in FIG. 3, to perform detection on multiple sensor pads through the input terminals simultaneously or time-divisionally. The number of AFE circuits and op-amps included in the readout circuit and the number of input terminals connected to the same op-amp should not be used to limit the scope of the present invention.

In addition, the circuit structure shown in FIGS. 6A and 6B are merely an example for illustrating the possible structure of the output circuit of the present invention. According to the present invention, the output circuit of a source driving circuit may include multiple data channels, each of which may include an op-amp configured to be coupled to a pair of output terminals with the feedback structure as shown in FIGS. 6A and 6B, to output the data voltages to the display panel based on polarity inversion. The display panel may be, but not limited to, an LCD panel, a light-emitting diode (LED) panel, or a plasma display panel (PDP), where the polarity inversion scheme may or may not be applied. In another embodiment, an op-amp may be coupled to an output terminal of the output circuit in a one-to-one mapping with the feedback node directly connected to the output terminal.

With the feedback mechanism where the feedback path of the op-amp includes a replica channel directly connected to the input/output pad of the readout circuit or the output circuit, the influences of the resistance in the readout channel or output channel may be minimized. It can be considered that the resistance in the signal path is eliminated, thereby increasing the signal transmission capability and the driving capability of the op-amp. The transmitted signal may be any possible signal output by the op-amp, such as a sensing signal received by the readout circuit, a voltage signal output by the source driving circuit, or any other type of signal that may be forwarded in the circuit. As long as the op-amp is connected in a manner where the feedback path is composed of a signal channel and a replica channel having identical circuit elements and implementations, the resistance in the feedback path may be equivalently eliminated. The related implementations should belong to the scope of the present invention.

To sum up, the present invention provides a readout circuit and an output circuit having an op-amp. The feedback path of the op-amp is directly connected to the input/output terminal of the readout circuit and the output circuit through a replica channel. The replica channel may have circuit element(s) and implementation(s) identical to those in the main signal channel such as the readout channel or the output channel of the circuit. In such a situation, the feedback node of the op-amp is on the terminal farther from the op-amp such as the input terminal of the readout circuit or the output terminal of the output circuit, such as the input/output pad of the IC. The feedback mechanism may reduce the influences of the resistance in the signal path between the op-amp and the feedback node, so as to increase the signal transmission capability and the driving capability of the op-amp.

Those skilled in the art will readily observe that numerous modifications and alterations of the device and method may be made while retaining the teachings of the invention. Accordingly, the above disclosure should be construed as limited only by the metes and bounds of the appended claims.

1. A readout circuit, comprising:
a plurality of input terminals; and
an amplifier, coupled to at least two of the plurality of input terminals through a readout channel and a replica channel, the amplifier comprising:
a positive input terminal;
a negative input terminal, coupled to each of the at least two input terminals of the readout circuit through the replica channel; and
an output terminal, coupled to each of the at least two input terminals of the readout circuit through the readout channel.

2. The readout circuit of claim 1, further comprising:
at least one first switch, each comprised in the readout channel and coupled between the output terminal of the amplifier and one of the at least two input terminals of the readout circuit; and
at least one second switch, each comprised in the replica channel and coupled between the negative input terminal of the amplifier and one of the at least two input terminals of the readout circuit.

3. The readout circuit of claim 1, further comprising:
at least one first electrostatic discharge (ESD) protection resistor, each comprised in the readout channel and coupled between the output terminal of the amplifier and one of the at least two input terminals of the readout circuit; and
at least one second ESD protection resistor, each comprised in the replica channel and coupled between the negative input terminal of the amplifier and one of the at least two input terminals of the readout circuit.

4. The readout circuit of claim 1, wherein the readout circuit is comprised in a sensing circuit, which is configured to be coupled to a sensor through the plurality of input terminals of the readout circuit.

5. The readout circuit of claim 4, wherein the readout circuit is configured to detect a stylus on the sensor.

6. The readout circuit of claim 1, wherein the amplifier is configured to detect a voltage signal on one of the plurality of input terminals.

7. The readout circuit of claim 6, wherein the positive input terminal of the amplifier is coupled to a reference node, for receiving a reference voltage having a value different from a value of the voltage signal.

8. The readout circuit of claim 1, wherein each of the plurality of input terminals of the readout circuit comprises an input pad.

9. An output circuit, comprising:
a plurality of output terminals; and
an amplifier, coupled to at least one of the plurality of output terminals through an output channel and a replica channel, the amplifier comprising:
a positive input terminal;
a negative input terminal, coupled to each of the at least one output terminal of the output circuit through the replica channel; and
an output terminal, coupled to each of the at least one output terminal of the output circuit through the output channel.

10. The output circuit of claim 9, further comprising:
at least one first switch, each comprised in the output channel and coupled between the output terminal of the amplifier and one of the at least one output terminal of the output circuit; and
at least one second switch, each comprised in the replica channel and coupled between the negative input terminal of the amplifier and one of the at least one output terminal of the output circuit.

11. The output circuit of claim 9, further comprising:
at least one first electrostatic discharge (ESD) protection resistor, each comprised in the output channel and coupled between the output terminal of the amplifier and one of the at least one output terminal of the output circuit; and
at least one second ESD protection resistor, each comprised in the replica channel and coupled between the negative input terminal of the amplifier and one of the at least one output terminal of the output circuit.

12. The output circuit of claim 9, wherein the output circuit is comprised in a source driving circuit, which is configured to be coupled to a display panel through the plurality of output terminals of the output circuit.

13. The output circuit of claim 12, wherein the output circuit is configured to output image data voltages to the display panel.

14. The output circuit of claim 13, wherein the positive input terminal of the amplifier is coupled to a digital-to-analog converter (DAC), for receiving the image data voltages from the DAC.

15. The output circuit of claim 9, further comprising:
a third switch, coupled between the negative input terminal of the amplifier and the output terminal of the amplifier.

16. The output circuit of claim 9, wherein each of the plurality of output terminals of the output circuit comprises an output pad.
